(19) United States
(12) Patent Application Publication
(10) Pub. No.: US 2017/0094039 A1
(43) Pub. Date: Mar. 30, 2017

(54) TOUCH SCREEN PROTECTOR

(71) Applicant: Liwei LU, Santa Clara, CA (US)

(72) Inventor: Liwei LU, Santa Clara, CA (US)

(21) Appl. No.: 14/866,940

(22) Filed: Sep. 26, 2015

(51) Int. Cl. H04M 1/02; B32B 17/10; B32B 3/02

(52) U.S. Cl. CPC H04M 1/0266; B32B 3/02; B32B 17/10779; B32B 2307/412; B32B 2307/41; B32B 2307/558; B32B 2457/208; B32B 2571/00

(57) ABSTRACT

A touch screen protector for a portable electronic device having a glass touch screen with a curved outer perimeter edge. The touch screen protector has a glass sheet and a curved edge portion that corresponds in shape to the curved outer perimeter edge. The curved edge portion is capable of accommodating the curved outer perimeter edge when the touch screen protector is mounted to the device, so as to provide maximum protection for the touch screen.

### FIELD OF THE INVENTION

The present disclosure generally relates to a touch screen protector. In particular, the present disclosure relates to a glass touch screen protector for electronic devices.

### BACKGROUND OF THE INVENTION

Since the rise of touch screen portable electronic devices, such as iPhones in global market, there is an ever-increasing demand for effective touch screen protectors. Several kinds of touch screen protectors have been developed, among which a premium tempered glass screen protector offers maximum protection. However, some newly developed portable electronic devices, such as iPhone 6 series, Nokia Microsoft phone, contain touch screens that has a curved outer perimeter edge, which brings a particular challenge for glass touch screen protectors. Conventional glass touch screen protectors have a planar glass sheet that cannot effectively accommodate the curved edge of the touch screen. On the other hand, the perimeter edge of the touch screen is the part most often being hit when the electronic device is dropped, which makes the perimeter edge most vulnerable and in need of protection. Therefore, a glass touch screen protector that provides protection to the curved outer perimeter edge is needed.

### SUMMARY OF THE INVENTION

The present disclosure provides a touch screen protector for a portable electronic device having a glass touch screen. In an aspect, the present disclosure provides a touch screen protector for a portable electronic device having a glass touch screen with a curved outer perimeter edge. In certain embodiments, the touch screen protector has a glass sheet and a curved edge portion that corresponds in shape to the curved outer perimeter edge. The curved edge portion is capable of accommodating the curved outer perimeter edge when the touch screen protector is mounted to the device.

In certain embodiments, the curved edge portion is made of glass and is comprised in the glass sheet. Preferably, the glass sheet that comprises the curved edge portion is made by the combination of etching and heat bending.

In certain embodiments, the curved edge portion is made of a flexible material, such as silicone, aluminum, rubber etc.

These and other features, aspects, and advantages of the present invention will become better understood with regard to the following description, appended claims and accompanying drawings.

### BRIEF DESCRIPTION OF THE FIGURES

FIG. 1 shows an exemplary portable electronic device.

FIG. 2 shows the side view of an exemplary portable electronic device.

FIG. 3 shows an exemplary touch screen protector according to the disclosure herein.

FIG. 3A shows an exemplary touch screen protector according to the disclosure herein.

FIG. 4 shows the cross-sectional view of an exemplary touch screen protector according to the disclosure herein.

FIG. 4A shows the cross-sectional view of an exemplary touch screen protector according to the disclosure herein.

FIG. 5 shows an exemplary touch screen protector according to the disclosure herein in close to a portable electronic device onto which the exemplary touch screen protector is mounted.

### DETAILED DESCRIPTION OF THE INVENTION

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Where a range of value is provided, it is understood that each intervening value, to the tenth of the unit of the lower limit unless the context clearly dictate otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, the embodiments described herein can be practiced without there specific details. In other instances, methods, procedures and components have not been described in detail so as not to obscure the related relevant function being described. Also, the description is not to be considered as limiting the scope of the implementations described herein. It will be understood that descriptions and characterizations of the embodiments set forth in this disclosure are not to be considered as mutually exclusive, unless otherwise noted.

The following definitions are used in the disclosure:

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “front glass” as used herein in general means a single glass sheet that includes an operable touch screen portion and a non-functional band around the perimeter of the touch screen portion. The front glass may also include one or more inoperable portions, however, such front glass will always include an operable touch screen portion. The term “touch screen portion” as used herein means the functional portion of the front glass of the portable electronic device. The term “non-functional band” as used herein means the area surrounding the touch screen portion of the front glass of the portable electronic device which is not touch sensitive.

As used herein, the curved edge refers an arc-shaped portion that connects the flat portion of the front glass with a side edge of the device. The term “all-curved outer parameter edge” means that all the outer parameter edges of the front glass are curved. For example, a typical mobile phone has a front glass that has four outer parameter edges. In such case, a front glass that has an all-curved outer parameter edge means all four outer parameter edges of the front glass are curved. In certain embodiments, the side edge of the device is also curved and the front glass curves seamlessly to the side edge of the device. In the context of a touch screen protector, a curved edge portion refers to a portion that is arc-shaped on both front side and the back side (i.e., the front side is convex and back side is concave).

As used herein, a portable electronic device includes, without limitation, a mobile telephone, reading device, music device, viewing devices, navigation device or other portable electronic device. Examples of such electronic devices are iPhone, Nook, iPod, iPad, Droid, and GPS systems. A glass touch protector can be designed and adapted to conform to the touch screen of any such portable device. For example, the shape of the glass touch screen protector can have corners that are rounded or beveled to match those of the portable electronic devices.

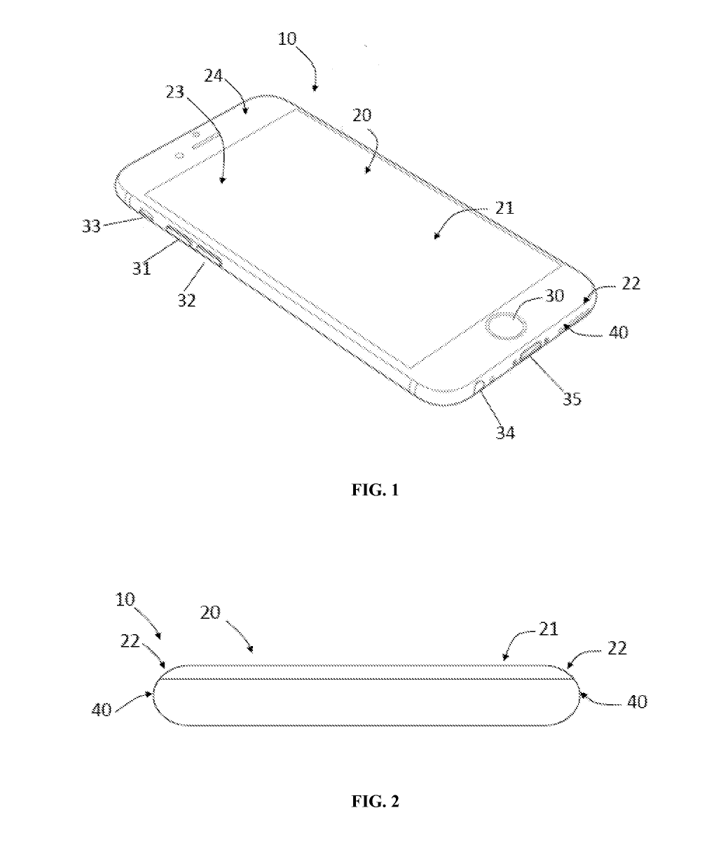

More recently, some portable electronic devices, such as Samsung Galaxy S6 and iPhone 6 series, have begun to use a front glass that includes a curved parameter edge. Notably, some portable electronic devices, such as iPhone 6 series, use front glass that has an all-curved outer parameter edge. FIG. 1 illustrates an example of a portable electronic device 10 having a front glass 20 that has a flat portion 21 and an all-curved outer parameter edge 22. The device 10 has a side edge 40. The flat portion 21 of the front glass 20 curves to the side edge 40 via the curved outer parameter edge 22. In certain examples, the side edge 40 is itself curved or arc-shaped, and in such instances the extreme end may be considered the side edge 40. The front glass 20 has a touch screen portion 23 for operation of the device as well as non-functional band 24 around the touch screen portion 23. In certain examples, the non-functional band 24 is omitted, minimized or reduced. In such examples, there may be no non-functional band 24 on the lateral sides of the touch screen portion 23 but only above and below the touch screen portion 23. Alternatively, the non-functional band may be absent from above and below the touch screen portion 23, and only present on either lateral side of the touch screen portion 23. Alternatively, the non-functional band 24 is entirely omitted, and the entire front glass 20 is functional (and thus the touch screen portion 23 is coextended and the same as the flat portion 21 or the front glass 20).

The portable electronic device 10 can also have a general function button 30 as well as other functional buttons such as volume buttons 31, 32 or mute button 33. The portable electronic device 10 can also have an earphone jack 34 and charging port 35.

To illustrate the curved edge of the front glass 20, a side view of the portable electronic device 10 is shown in FIG. 2. The portable electronic device 10 has a front glass 20 with a flat portion 21 and a curved outer parameter edge 22. In the illustrated embodiment, the side edge 40 itself is curved and the front glass 20 curves seamlessly to the side edge of the device. In such case, the extreme side end is considered as side edge 40.

In one aspect, the present disclosure provides a glass touch screen protector that can be used to protect the front glass of the portable electronic device 10. Conventional glass touch screen protectors have a planar glass sheet that cannot effectively accommodate the curved outer parameter edge 22 of the front glass 20. However, the perimeter edge of the front glass is the part most often being hit when the portable electronic device 10 is dropped, which makes the outer perimeter edge 22 most vulnerable and in need of protection. As further disclosed below, a curved edge portion is employed in the touch screen protector to accommodate the outer perimeter edge of the front glass so as to provide increased protection for the front glass.

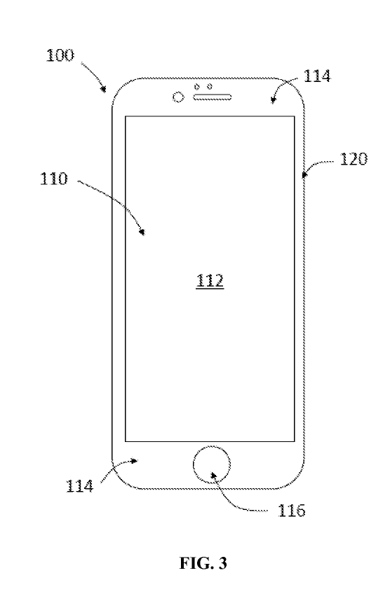

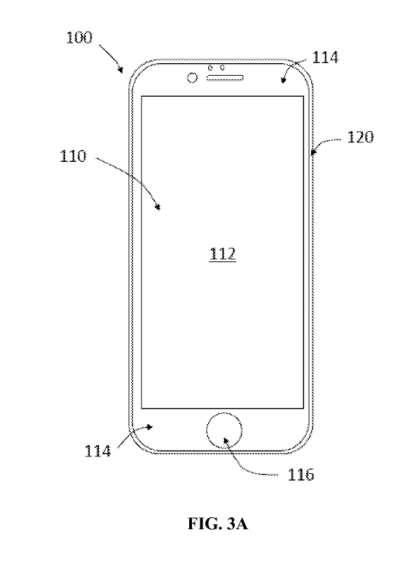

FIG. 3 shows a top view of a touch screen protector in accordance with an exemplary embodiment. As illustrated, the touch screen protector 100 can correspond to the shape of the front glass of a portable electronic device, and thus can be generally rectangular. In other examples, the shape of the touch screen protector 100 can be rounded or have other polygonal shape to correspond to the shape of the desired device and touch screen. The touch screen protector 100 can include a glass sheet 110 and a curved edge portion 120. In some examples, the glass sheet 110 and the curved edge portion 120 can be a single component. In some examples, the glass sheet 110 and the curved edge portion 120 can be different components.

The glass sheet 110 can include a transparent window portion 112 and a band 114 surrounding the perimeter of the transparent window portion 112. In some examples, the transparent window portion 112 and the band 114 can be a single component. In some examples, the transparent window portion 112 and the band 114 can be different components.

The transparent window portion 112 can substantially correspond to the touch screen portion of the front glass. The light transmission of the transparent window portion 112 can be from 60 to 99%, alternatively from about 90˜99%. The transparent window portion 112 can be made of any suitable transparent material available. The transparent window portion 112 can be silica based. In some embodiments, the transparent window portion 112 can be soda-lime glass, lead glass, flint glass, sodium borosilicate glass, oxide glass or any other suitable transparent material. In some preferred embodiments, the transparent window portion 112 can be made of Gorilla Glass by Corning Inc. of Corning, N.Y.

The band 114 can essentially conform to the non-functional band that surrounds the touch screen portion. The band 114 can include one or more holes 116 that corresponds to the general function button of the portable electronic device. By exposing the buttons for ease of operation, the one or more hole 116 can act as alignment features to facilitate proper mounting of the touch screen protector 100 on the portable electronic device. In some portable electronic devices, the non-functional band surround the touch screen portion may be omitted, minimized or reduced. Accordingly, in same embodiments, the band 114 can be omitted from the touch screen protector 100. The band 114 can be opaque or non-opaque. Accordingly, in some embodiments, when the window portion 112 and the band 114 are the same component, the opacity can be provided by a layer of ink or paint on the surface of the band 114. In other embodiments, the band 114 can be tinted glass.

The curved edge portion 120 can essentially conform to the all-curved outer perimeter edge of a portable electronic device. When the touch screen protector is mounted to the device, the curved edge portion 120 is capable of accommodating the curved outer perimeter edge. This permits the touch screen protector to extend across the flat portion of the front glass to the curved outer perimeter edge of the front glass. In preferred embodiments, the curved edge portion 120 corresponds in shape to the all-curved outer perimeter edge. In such case, the front side of the curved edge portion 120 is also curved. The front side of the curved edge portion 120 is the side that is furthest to the front glass when the touch screen protector 100 is adhered to the portable electronic device. In other words, the back side (the side in touch with the glass front when mounted to the electronic device) of the curved edge portion 120 is concave and the front side is convex. As a result, the curved edge portion 120 extends seamlessly to the curved edge of the portable electronic device when the touch screen protector 100 is mounted to the portable electronic device.

In some embodiments, the curved edge portion 120 and the glass sheet 110 can be a single component. In such case, the curved edge portion 120 can be made of glass and can be comprised in the glass sheet 110.

In certain embodiments, the curved edge portion 120 and the glass sheet 110 can be different components. For example as shown in FIG. 3A, the glass sheet 110 is essentially flat and the curved edge portion 120 can be made of a material other than glass, such as silicone, aluminum, rubber, ceramics, etc.

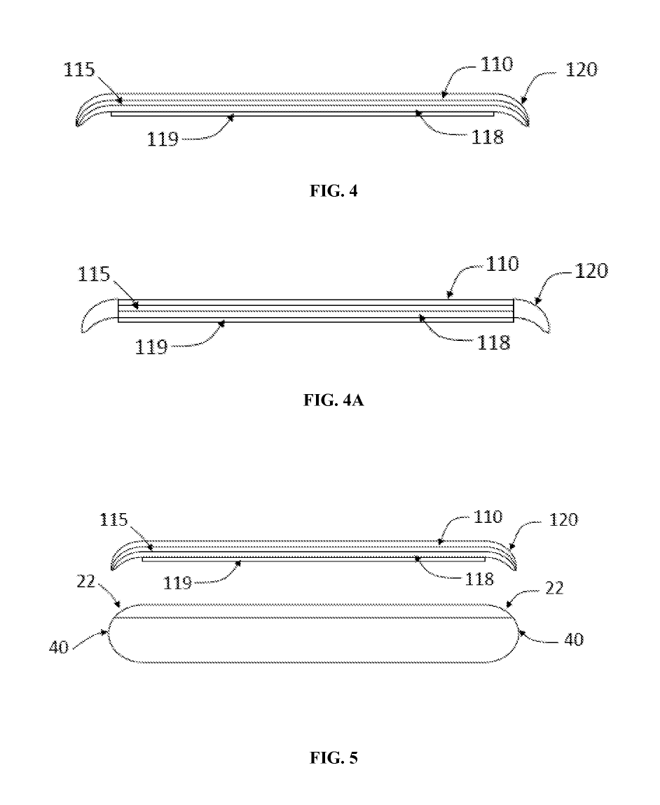

In order to illustrate the curved edge portion, a cross-sectional view of touch screen protector 100 is shown in FIG. 4. The thickness of the glass sheet 110 can be in the range of about 0.01 mm to 1.0 mm, preferably 0.01 mm to 0.6 mm. The glass sheet 110 can have a paint layer 115. The paint layer 115 can be the band 114 that can essentially conform to the non-functional band that surround the touch screen portion of the portable electronic device. The paint layer can be 1.0 mm or less in thickness. In some embodiments, an anti-shatter membrane 118 can be adhered to the underside of the paint layer 115 and glass sheet 112. For example, because the paint layer 115 extends only around the perimeter of the glass sheet, the anti-shatter membrane 118 adheres to the paint layer 115 around this perimeter and directly to the glass sheet 110 around the transparent window portion 104. If no paint layer 115 is provided, the anti-shatter membrane 118 can be adhered directly to the entire underside of the glass sheet 110. Accordingly, the anti-shatter membrane adheres directly or indirectly to the underside of the glass sheet (beneath both the transparent window portion 112 and band 114). The anti-shatter membrane prevents the glass sheet 110 from shattering, and if shatters, aids in preventing the glass from breaking into smaller scattered pieces which can endanger the fingers of a user. The anti-shatter membrane 118 can be made up of a transparent flexible polymeric material such as PET or other adhesive material. The anti-shatter membrane 118 can be adhered to the glass sheet and paint layer 115 by a strong adhesive, for example an optical grade acrylic adhesive. The anti-shatter membrane 118 can be from 0.01 to 0.25 mm, alternatively from 0.1 to 0.2 mm in thickness. The glass sheet 110 can be compressed to cause the glass to be one or more of strengthened, tempered, and convex.

In some embodiments, the curved edge portion 120 and the glass sheet 110 is a single component, i.e., the curved edge portion 120 is made up of glass and is comprised in the glass sheet 110. The paint layer 115 and the anti-shatter membrane 118 can extend across the flat portion of the touch screen protector to the curved edge portion 120. In such embodiments, the glass sheet that includes a curved edge portion can be made by etching or heat bending. In certain preferred embodiments, the glass sheet that includes a curved edge portion can be made in the combination of etching or carving and heat bending. Typically, a piece of glass (e.g., Gorilla Glass) is cut to thick flat individual small part and etched to create a glass sheet that fits the size and the curved outer perimeter edge of the front glass of the portable electronic device. The glass is further treated with heat bending to correct the deformation of the glass sheet during the cutting and etching so that the glass sheet contains a curved edge that can seamlessly matches the curved outer perimeter edge of the front glass when the touch screen protector is mounted to the portable electronic device.

In some embodiments, an adhesive layer 119 can adhere directly or indirectly underside the glass sheet 110. For example, the adhesive layer 119 adheres directly or indirectly to the underside of the glass sheet (beneath both the transparent window portion 112 and band 114). The outermost of the adhesive layer 119 can be an exposed adhesive for contact with the front glass of a portable electronic device. The adhesive layer 119 can be from 0.01 to 0.5 mm, alternatively 0.01 to 0.2 mm, and alternatively about 0.1 mm in thickness. The adhesive layer 119 can be made up of any type of adhesive, for example, acrylic adhesive or silicone adhesive. In some embodiment, the adhesive is electron (capacity) conductive so that the touch screen protector has increased conductive to finger touch (e.g., point, tap, drag pinch and spread) and increased precision of instruction. The adhesive layer 119 can be adhered to the glass sheet 110 and paint layer 115 by a strong adhesive, for example an optical grade acrylic adhesive.

In some embodiments, the touch screen protector 100 further comprises a privacy reflection layer. Such a privacy reflection layer can reflect the light such that the content of the touch screen is only visible from right in front of the screen but invisible from the outside. In certain embodiments, the privacy reflection layer and the adhesive layer 119 is a single component.

The cross-sectional view of an additional exemplary touch screen protector is shown in FIG. 4A. In this example, the curved edge portion 120 and the glass sheet 110 are different components. The curved edge portion 120 can be made of some materials other than glass, such as flexible materials. In one example, the curved edge portion 120 can be made of silicone. To create such edge portion, the sides of glass sheet can be treated to generate microscopic pores. The treated glass sheet can then be placed in a mold that fit the size and shape of the front glass with sides of the glass sheet covered with silicone (typically 0.05˜2 mm in width).

In some embodiments, the touch screen protector disclosed herein also has a backing member to protect a back side of the touch screen protector and the exposed adhesive. The back side of the touch screen protector is the side that is closest to the portable electronic device when the touch screen protector is adhered to the portable electronic device. The backing member can include a tab to assist in the removal of the backing member prior to mounting the glass touch screen protector onto the portable electronic device. By grasping and pulling on the tab, the backing member can be removed completely from the glass touch screen protector thereby exposing the adhesive prior to mounting the glass touch screen protector to the non-functional border of the touch screen portion of the portable electronic device. The backing member can include surface which permits adherence of the backing member to the back side of the glass touch screen protector as well as easy removal, and can optionally have adhesive thereon. There are various adhesives as described herein that are commercially available and a skilled artisan can select the particular adhesive for the specific application of adhering the backing member to the back side of the glass touch screen protector.

In another aspect, the present disclosure provides a method for adhering a glass touch screen protector to a portable electronic device. An exemplary method is provided by way of example, as there are a variety of ways to carry out the method. In such embodiments, the screen of a portable electronic device is cleaned. For example, a user can use a microfiber cloth or other suitable cleaner to wipe away any dust particles on the screen of portable electronic device 10. The microfiber cloth can be included in the original packaging or can be an aftermarket microfiber cloth. After cleaning the front glass of the portable electronic device 10, the method can proceed to peel off a backing member of the glass touch screen protector. For example, the backing member can be removed to expose the exposed adhesive protected by the backing member. After removing the backing member, the method can proceed to align the glass touch screen protector onto the portable electronic device. For example, a user can align the bottom of the glass touch screen protector 100 at the bottom including aligning any button holes. After aligning the glass touch screen protector 100 onto the portable electronic device 10, the method can proceed to apply pressure onto the glass touch screen protector to mount the glass touch screen protector on the portable electronic device. For example, the user can apply pressure on the glass touch screen protector 100, thereby pressing the exposed adhesive against the portable electronic device 10, to mount the glass touch screen protector 100 onto the portable electronic device 10. After the glass touch screen protector 100 is mounted on the portable electronic device, the glass touch screen protector 100 can be removed and the method can be executed again.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

1. A touch screen protector for a portable electronic device having a front glass that includes a touch screen portion and an all-curved outer perimeter edge, the touch screen protector comprising:
a glass sheet comprising a front side and a back side, and comprising a transparent window portion that corresponds in size to the touch screen portion and a curved edge portion that corresponds in shape to the all-curved outer perimeter edge, wherein both the front side and the back side of the curved edge portion have an arc-shape and the curved edge portion is capable of accommodating the all-curved outer perimeter edge when the touch screen protector is mounted to the device.

2. (canceled)

3. The touch screen of claim 2, wherein the glass sheet is made by the combination of etching and heat bending.

4. The touch screen protector of claim 1, wherein the curved edge portion is made of a flexible material.

5. The touch screen protector of claim 4, wherein the flexible material is silicone.

6. The touch screen protector of claim 1, wherein the glass sheet has a thickness of between 0.01˜1.0 mm.

7. The touch screen protector of claim 1, wherein the device has a non-functional band surrounding the touch screen portion and the glass sheet comprises an opaque portion that corresponds in size to the non-functional band.

8. The touch screen protector of claim 7, wherein the opaque portion is a paint layer.

9. The touch screen protector of claim 1, further comprising one or more alignment holes that substantially correspond to one or more buttons on the device.

10. The touch screen protector of claim 1, further comprising an anti-shatter membrane.

11. The touch screen protector of claim 1, further comprising a privacy reflection layer.

12. The touch screen protector of claim 11, further comprising an exposed adhesive layer.

13. The touch screen protector of claim 12, wherein the adhesive layer has a strength enabling repeated removal and re-attachment.

14. The touch screen protector of claim 12, wherein the exposed adhesive layer and the privacy reflection layer is a single component.

15. The touch screen protector of claim 12, further comprising a back member protecting the exposed adhesive layer.
